(19) United States
(12) Patent Application Publication
(10) Pub. No.: US 2010/0315568 A1
(43) Pub. Date: Dec. 16, 2010

(54) Liquid crystal devices and methods providing fast switching mode

(75) Inventors: Liang-Chy Chien, Hudson, OH (US); Shin-Ying Lu, Kent, OH (US); Lu Lu, Kent, OH (US)

Correspondence Address: HAHN LOESER & PARKS, LLP, One GOJO Plaza, Suite 300, AKRON, OH, 44311-1076, US

(73) Assignee: KENT STATE UNIVERSITY, Kent, OH (US)

(21) Appl. No.: 12/802,916

(22) Filed: Jun. 16, 2010

Related U.S. Application Data
(60) Provisional application No. 61/268,753, filed on Jun. 16, 2009.

(51) Int. Cl. G02F 1/133; G02F 1/1335; C09K 19/58

(52) U.S. Cl. 349/33; 349/117; 252/299.01; 977/902; 977/742

(57) ABSTRACT

A liquid crystal device includes carbon nanotube-doped liquid crystal materials that have a fast switching mode. The liquid crystals may be nematic liquid crystals contained in an optically controlled birefringence cell, with a small amount of nanotubes relative to the liquid crystals. The cell may operate between an optical bend state and homeotropic state, where the liquid crystals aligning in a bend state in response to low voltage and transform to a homeotropic state in response to high voltage. The cell may capable of a large change in effective birefringence, or variable effective birefringence enabling self-compensated optical retardation. The liquid crystals may be included with an electro-optical film, which may be formed with polymer encapsulated liquid crystals with the inclusion of at least a small amount of nanotubes sufficient to induce homogeneous liquid crystal dispersion. The electro-optical film may be fabricated by lamination or otherwise onto a substrate.

### CROSS-REFERENCE TO RELATED APPLICATIONS

This patent application claims the benefit of U.S. Provisional Patent Application No. 61/268,753 filed Jun. 16, 2009, the disclosure of which is expressly incorporated by reference herein.

### BACKGROUND

This invention relates in general to liquid crystal devices and methods to provide fast switching modes. The invention may be used in liquid crystal devices such as Liquid Crystal Displays (LCD). LCDs are found in many electronic devices, including televisions, computer monitors, Personal Data Assistants (PDAs), mobile phones, and the like, just for example.

Liquid crystal (LC) devices are generally unique because of their prolific use in displays ranging from hand-held mobile devices to large screen televisions. High speed switching is an important feature for liquid crystal devices for many applications, such as featuring motion picture quality displays and/or spatial light modulation. To have motion picture quality displays for example, there is a need to find a suitable display mode to shorten the response time of the device. Among the available display modes liquid crystal pi-cells not only have the intrinsic wide viewing angle characteristics because the self-compensated liquid crystal director configuration, but also fast switching between the bend and homeotropic state. However, the fall time of LC pi-cells is still slow. Many efforts have attempted to improve the essential electro-optical properties of the existing LCs including the use of nano-particles. In such attempts, in the LC matrix, among other attributes, good miscibility of nanoparticles has not been achieved in the nematic host to provide long term device stability.

Among liquid crystal display technologies, it has been found that optically compensated birefringence (OCB) cell technology is a possible switching mode for motion picture quality displays.

In an OCB cell, the display device normally comprises of a pair of substrates, with alignment layers that are unidirectionally rubbed, with the substrates assembled by orienting the directions of rubbing in a parallel fashion. A liquid crystal is disposed between the substrates and oriented by the alignment layers. At the non-activated state, the device is in the maximum transmittance when the rubbing direction is placed at 45° in between crossed polarizers.

One advantage of the OCB cell is a wide view angle arising from the bend structure where the director orientation self-compensates the phase retardation when light comes in from oblique angles. However, at issue is the transitions between splay and bend state when the pretilt angle is low in the OCB cell. Therefore, a holding voltage is required to prevent switching to splay configuration; and thus, the device can maintain high switching speeds between the bend and homeotropic state.

When high voltage is applied to the cell, it is switched to a homeotropic or no light transmitting state in which most of the liquid crystal molecules are aligned in a direction perpendicular to the cell. The response time for the “voltage-on” state is much faster than that of the most nematic devices. Yet, as for most nematic devices, including the OCB cell, the response time for the “voltage-off” relaxation is the limiting factor related to the long image refreshing time. Typically, in relaxation, no torque is applied to the local directors near the center of the cell. By using a nematic liquid crystal that is aligned parallel, the switching mechanism resides in the fact that liquid crystal is elastically deformed by the surfaces, such that liquid crystal, initially at a bend state, transforms to a homeotropic state when an electric field is applied. When the electric field is turned off, the fall time of the OCB cell, compared with the rise time is relatively long. In general, the turn-off or fall time (t_{fall}) of an OCB cell depends on the cell gap (d), rotational viscosity of liquid crystal (γ), and effective elastic constant of liquid crystal (K) according to the formula t_{fall}=γ d²/K p². It would be desirable to shorten the fall time of the OCB cell.

There have been efforts directed at doping nanoparticles into liquid crystal for the purpose of modifying the physical properties of liquid crystals, for example to shorten the response time. For example, carbon nanotubes (CNTs) doped nematic liquid crystals have been used in twisted-nematic (TN) liquid crystal cells, with improved rise time due to the lowering of the threshold voltage. However, the fall time was also increased because of the increase in viscosity. It would be desirable to provide improvement in both rise time and fall time in TN cells.

Additionally, emerging functional materials, such as liquid crystal polymer composites, which are a class of electro-optical materials, have led to the development of a variety of optical and electro-optical devices. Among the liquid crystal polymer composites, the electro-optical film (EOF) based on polymer encapsulated liquid crystals appear to have unique optical and electro-optical properties. Polymer encapsulation may be achieved through either emulsification or phase separation, as with polymer dispersed liquid crystal (PDLC). PDLCs have been developed for some time and yet it would be desirable to provide further improvement in the function and operation of such PDLCs.

Generally, PDLC films can be fabricated by two methods, namely, by coating an emulsion of a liquid crystal dispersed in an aqueous-based film-forming polymer and by phase separation of a polymer from a single-phase mixture containing the polymer and liquid crystal. The phase separation processes include for example polymerization induced phase separation (PIPS), thermally-induced phase separation (TIPS), and solvent-induced phase separation (SIPS). In the PIPS process, the polymer separates from the liquid crystal during polymerization as the molecular chain length increases. For TIPS, the liquid crystal is mixed with a thermoplastic polymer in a melt. As the melt cools, the polymer begins to solidify causing the liquid crystal to phase separate. The phase separation process of an initially homogeneous mixture of polymer and liquid crystal results in Swiss-cheese-like polymer morphology with liquid crystal droplets filling in the holes. Liquid crystal molecules in these tiny droplets (a few microns across for practical applications) without orientational order at the inactivated state are responsible for the unique behavior of the material by forming a turbid, cloudy film.

A PDLC film may be sandwiched between two active electrodes, when the film in the off state with no applied voltage, there is no overall orientation of the liquid crystal molecules with the droplets. At this state, light scattering occurs at the interface between the droplets and the polymer matrix due to the refractive indices mis-matching and thus the film appears opaque. By applying a voltage to the PDLC film it becomes transparent in a certain range of viewing angle. Off-angle haze gives rise to indices mismatching between the anisotropic liquid crystal and the isotropic polymer matrix. Wider angle light scattering has been minimized by using a variety of methods including using a mesogenic polymer matrix.

Generally, PDLC displays have several important features which conventional display technologies do not. Some typical advantages of PDLC displays are that they are polarizers free, suitable for high light transmission, multiple mode operational (normal mode, reverse mode with liquid crystalline materials having a negative dielectric anisotropy and elongated droplet, passive matrix or active matrix driving method), and simply fabricated. Because a PDLC display cell does not require polarizers, low cost birefringent plastic substrates such a PET can be used. PDLCs may be made suitable for standard coating and printing techniques by forming them into polymer droplet dispersions. The display materials can be laminated between the substrates, coated or printed on the substrate.

Such PDLC films have slow response time, dependent on the liquid crystal director configuration and the droplet sizes. Thus, there is a need in the art for PDLCs with all of their aforementioned benefits, but which can be practically implemented by improving the response time. Therefore, it is desired to provide a PDLC film that is fast switching in response time.

### SUMMARY

This invention relates particularly to a liquid crystal devices and methods including carbon nanotube-doped liquid crystals that have a fast switching mode.

In one example, optically controlled birefringence (OCB) mode displays are prepared with nematic liquid crystal cells doped with carbon nanotubes to facilitate the fast switching characteristics. The liquid crystal layer may include nematic liquid crystal materials containing a dispersion of a small amount of carbon nanotubes. An OCB liquid crystal display containing CNT doping according to the invention such shows significant improvements in response time.

The present invention also relates to methods of fabricating fast switching liquid crystal cells. For example, pi-cells including a predetermined amount of nanotube-doped liquid crystal may be included in an LCD. The methods are based on the relationship between the enhancement of response time of nanotube-doped liquid crystals and the elastic and viscosity properties of the composition including the liquid crystals. Furthermore, nanotube doping with the predetermined amount of nanotubes can also improve the dielectric anisotropy of the host liquid crystal. The compositions and the methods and processes of this invention are usefully employed in displays and spatial light modulators to provide improved response time for example.

In an example, optically controlled birefringence (OCB) mode carbon nanotube doped liquid crystal cells according to the present invention may be utilized in a variety of applications where fast switching, low operating voltage, and/or wide viewing angle are desirable, such as Liquid Crystal Displays, Spatial Light Modulators, LC Telecommunications, or Adaptive Optics Components.

The invention also relates to compositions and methods wherein a dispersion of functionalized or surfactant-treated CNTs in a nematic liquid crystal enhances the switching time of an OCB cell. Electro-optical observations in such a nanotubes-doped nematic for OCB cells reveal fast switching time. In one such a liquid crystal cell, the electric-field-induced bent-to-homeotropic transition does not require a 90° rotation of the director along the long axis. At the non-activated state, the liquid crystal molecules are elastically deformed at a splay configuration because of surface constraints such that long axis of the nematic material is oriented in the direction parallel to alignment (such as by rubbing) direction of both alignment layers. At a low applied voltage, the cell is switched to a bend state in which a middle layer of liquid crystal molecules are perpendicular to the cell substrates while those molecules increase the angle of tilt away from the surface responding to the field. Because of the surfactant-assisted dispersion of the CNTs, the orientation of mixed carbon nanotubes follows the direction of liquid crystal molecules throughout the cell. When a high field is applied to the cell, the liquid crystal molecules and nanotubes in the bulk are aligned parallel to the direction of the applied field, while those at or near the surface layers have stronger constraints to orient themselves perpendicular to the substrates.

The present invention additionally relates to electro-optical film (EOF) including carbon nanotube doped liquid crystals and polymer composites and methods of forming such EOF materials. In one example polymer and liquid crystal are mutually dispersed one in the other in the EOF, which is naturally opaque and becomes transparent to light by application of an electric field. In such a case, the EOF may be polarizers free, have a relatively fast response time and be suitable for use in flexible substrates and multiple stacked layers.

According to further examples, an EOF may include at least one substrate and a dispersion layer, which include polymer, liquid crystal and nanotubes or nanoparticles. Each of the dispersion layers may include regions of liquid crystal material dispersed in a polymer matrix material. Also, a liquid crystal display may include a substrate and a multi-layer stack of components of the display supported on the substrate, with the display including only one substrate if desired. The components of the display may include a plurality of liquid crystal dispersion layers.

Various aspects will become apparent from the following description and accompanying drawings.

### BRIEF DESCRIPTION OF THE DRAWINGS

The patent or application file contains at least one drawing executed in color. Copies of this patent with color drawing(s) will be provided by the Patent and Trademark Office upon request and payment of necessary fee.

For a complete understanding of the present invention, reference is made to the following detailed description and accompanying drawings, wherein:

FIG. 1a is a schematic view of a liquid crystal OCB cell according to an example of the invention in a splay state.

FIG. 1b is a schematic view of the LC cell of FIG. 1a in a low voltage-activated bend state.

FIG. 1c is a is a schematic view of the LC cell of FIG. 1a in a high voltage-switched homeotropic state.

FIG. 2a is a graph illustrating the dielectric spectroscopy of the real and imaginary parts of extraordinary dielectric constants of a first liquid crystal with and without CNT doping.

FIG. 2b is a graph illustrating the dielectric spectroscopy of the real and imaginary parts of extraordinary dielectric constants of a second liquid crystal with and without CNT doping.

FIG. 2c is a table showing the characteristics of four liquid crystals including response time improvements in CNT doped liquid crystal OCB cells.

FIG. 3a is a graph illustrating the transmission versus applied voltage curves of an OCB cell with and without CNT doping.

FIG. 3b is a graph illustrating the gray levels of the cell with CNTs of FIG. 3a.

FIG. 4a is a graph illustrating the measured gray-level response times, and the rise and fall times, of a first liquid crystal with and without CNT doping.

FIG. 4b is a graph illustrating the measured gray-level response times, and the rise and fall times, of a second liquid crystal with and without CNT doping.

FIG. 4c is a graph illustrating the measured gray-level response times, and the rise and fall times, of a third liquid crystal with and without CNT doping.

FIG. 4d is a graph illustrating the measured gray-level response times, and the rise and fall times, of a fourth liquid crystal with and without CNT doping.

FIG. 5a is a polarizing optical micrograph of electro-optical films constructed in accordance with an example of the invention showing dispersed liquid crystal droplets with a droplet size distribution from smaller than a micron to about 10 micron in size.

FIG. 5b is a micrograph similar to FIG. 5a showing dispersed liquid crystal droplets with uniform droplet size smaller than a micron.

FIG. 5c is a micrograph similar to FIG. 5b.

FIG. 6 is plot of transmission versus applied voltage of examples of EOFs of polymer and liquid crystal (40/60) by weight with different carbon nanotubes concentration.

FIG. 7a is plot of response time versus applied voltage of examples of EOFs having different CNTs concentration measured by rise time versus voltage.

FIG. 7b is plot of response time versus applied voltage of examples of EOFs having different CNTs concentration measured by fall time versus voltage.

FIG. 8 is plot of permittivity versus Frequency for a variety of samples having different CNTs concentration.

FIG. 9 is plot of the effect of LC concentration on the transmission-voltage curves of example EOFs based on LC concentration.

FIG. 10 is plot of effect of LC concentration on the response time of example EOFs measured by rise time versus voltage.

FIG. 11 is a table showing example polymerizable mixtures for EOF with varying amounts of component concentration and the resulting cell gaps and cell alignments.

### DETAILED DESCRIPTION

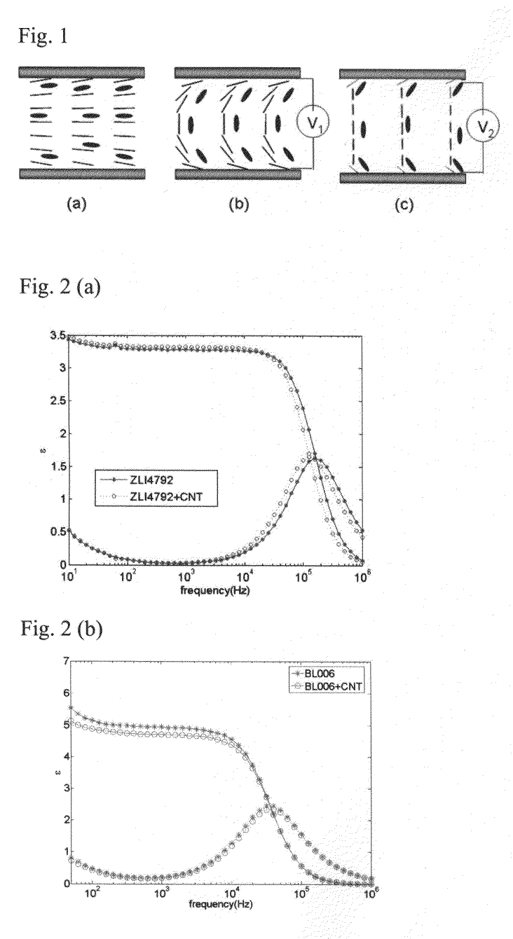

Referring now to the drawings, there is illustrated in FIG. 1a a liquid crystal (LC) Optically Controlled Birefringence (OCB) cell in a splay state, in which the thin sticks represent liquid crystal molecules and dark rods are the dispersed nanotubes. FIG. 1b is a schematic view of the LC cell of FIG. 1a in a low voltage-activated bend state. FIG. 1c is a is a schematic view of the LC cell of FIG. 1a in a high voltage-switched homeotropic state

For example, the principle operation of the OCB cell is illustrated. The electric-field-induced bent-to-homeotropic transition does not require a 90° rotation of the director along the long axis. At the non-activated state shown in FIG. 1(a), liquid crystal molecules are elastically deformed at a splay configuration because of surface constraints such that long axis of the nematic material is oriented in the direction parallel to an alignment direction, such as a rubbing direction, of both alignment layers. At a low applied voltage VI, the cell is switched to a bend state shown in FIG. 1(b) in which middle layer of liquid crystal molecules are perpendicular to the cell substrates while those molecules increase the angle of tilt away from the surface responding to the field. Because of the surfactant-assisted dispersion of CNTs as will be described, the orientation of mixed carbon nanotubes follows the direction of liquid crystal molecules throughout the cell. When a high field is applied to the cell, the liquid crystal molecules and nanotubes in the bulk are aligned parallel to the direction of the applied field shown in FIG. 1(c), while those at or near the surface layers are provided with stronger constraints to orient themselves perpendicular to the substrates.

The present example features a liquid crystal device consisting of two cell substrates, alignment layer and a nanotube-doped liquid crystal disposed in the cell. The above and other features of this example of the invention will become apparent from the following detailed description taken in connection with the accompanying drawings and illustrations which form a part of this specification. Other cell configurations may be provided.

In the present embodiment, there are provided surfaces for aligning the long axis of liquid crystal molecules parallel to the directions of unidirectionally rubbed alignment layers. Other alignment layers or methods of forming alignment layers may be used. A nematic liquid crystal is disposed into the cell where the cell gap is separated by spacers to maintain uniform thickness. In order to disperse nanotubes in nematic liquid crystals, three mixtures with different surface modifications may be used. The nanotubes, while not limited to any particular configuration, are selected from commercially-available single wall carbon nanotubes (SWNTs) for example, with a range of length between 50-500 nm and diameter of 5 nm. Example of concentration of carbon nanotubes used in this invention may be in the range of 0.001% to 0.10%. More particular examples may use concentrations in the range of 0.01% to 0.05%. The nanotubes may be treated with one or more surfactants, wherein, the surfactant used to treat the nanotubes may be selected from one or combination of several, for example, a low-molecular-weight surfactant such as dodecybenzene sulfonic acid, or macromolecular surfactants such as triton X-100 (polyethylene oxide-octylphenyl ether), poly(siloxane-b-ethylene oxide), etc. Functionalized carbon nanotubes such as functionalized fullerene pipes are also usable in this invention. The concentration of surfactant is between 10-50% by the weight of nanotubes for example.

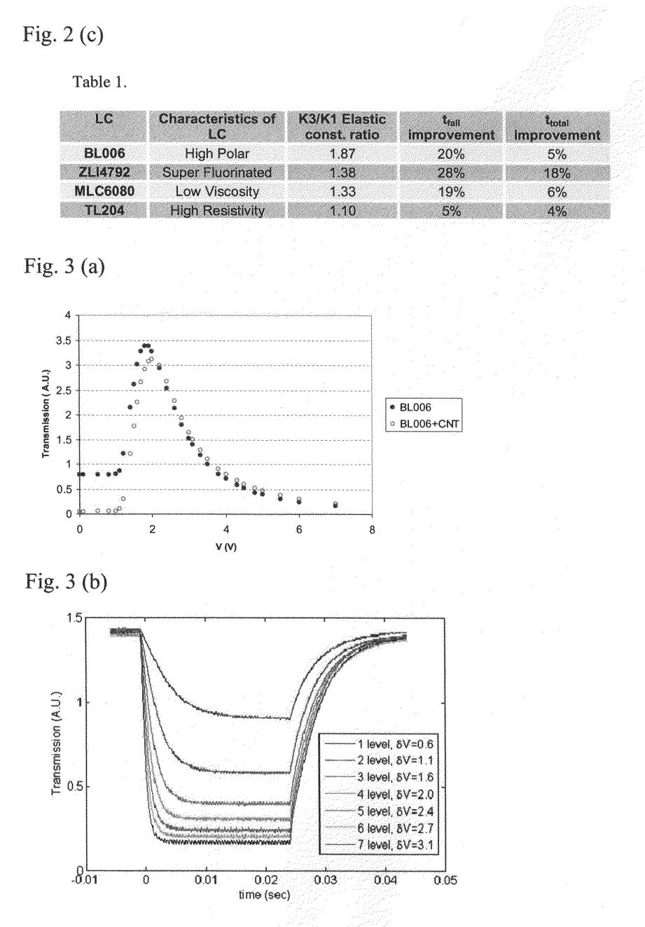

In examples, four liquid crystals, BL006, ZLI4792, MLC6080, and ZLI4792 were selected to show the effect of doping single-wall CNTs in nematic liquid crystals. These liquid crystals are used in different types of liquid crystal displays. The doping concentration of CNTs was 10⁻³%, and the mixture was put in ultra-sonic bath for 3 hrs until the CNTs are well-dispersed in the nematic liquid crystals. The mixtures were filled in cells by a capillary action at 100° C. The characteristics of the four liquid crystals are listed in Table 1 in FIG. 2c.

In table 1 example response times in the CNT doped liquid crystal OCB cells are shown. It should be noted that the percentage of improvement is calculated by dividing the difference of response time before and after doping CNT with the response time before doping CNT, e.g. (^{t}CNT−^{t}NLC)/^{t}NLC·^{t}CNT and ^{t}NLC are obtained by doing the average on the response time of the 7 gray levels.

In one example, operable OCB cells were prepared with CNTs doped nematic liquid crystals. The measurements of dielectric spectroscopy for are shown in FIGS. 2a and 2b. The CNT doped OCB cells demonstrate a minor increase or decrease of dielectric permeability in the TFT-LCD operation frequency (60-120 Hz), which indicate the electro-optical properties should remain similar to the pure nematic liquid crystal host. The dielectric properties of the nanotubes-doped nematic liquid crystals, as a function of method of surface of treatment on nanotubes, indicates a minor increase or decrease of the real part of dielectric permeability in the TFT-LCD operation frequency (60-120 Hz). The dielectric relaxation frequencies remain the same for all liquid crystals. The imaginary part of dielectric constant reveals a significant increase for nanotubes with only chemical treatment, but unchanged in conductivity for those having the additional surfactant modified or functionalized nanotubes doped liquid crystals. Thus, the invention offers substantial flexibility in fabrication and design of thin film transistor (TFT) based (active matrix addressed) liquid crystal displays that has not been previously possible in the display industry using nanoparticles or nanotubes doped liquid crystals.

A second example is illustrated in FIGS. 3a and 3b. FIG. 3a depicts the transmission versus applied voltage curves of an operable OCB cell. The results indicate similar response to the voltage ramping, and the voltage of the transition from splay to bend is not changed by the CNTs. The slight change in transmission at zero volts is due to the different phase retardation caused by the cell thickness variation of different cells. According to the transmission versus voltage curve of the OCB cell with CNT-doped liquid crystal, we select the bright state as gray level 0 and dark state as gray level 7. In between, 6 gray levels were selected according to the gamma curve which is commonly used in industry. An example of the transmission of the selected gray levels for the cell with CNT-doped BL006 is as shown in FIG. 3b similar optical response with the application of field.

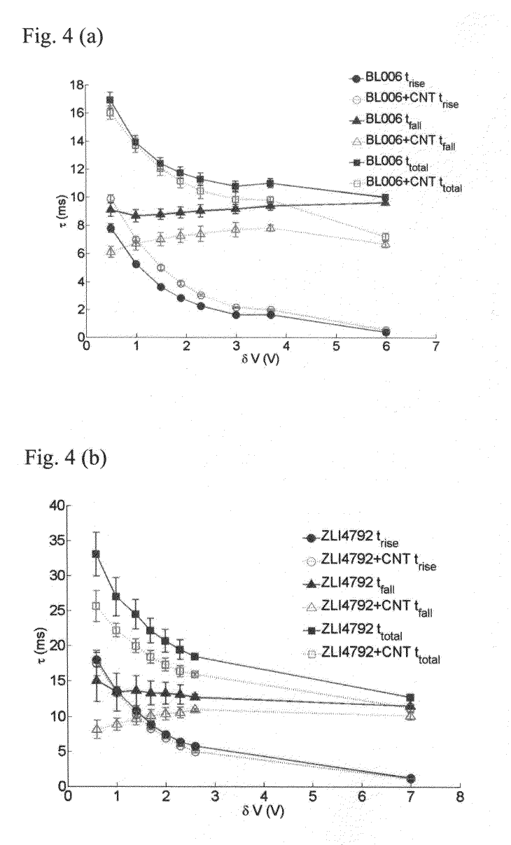

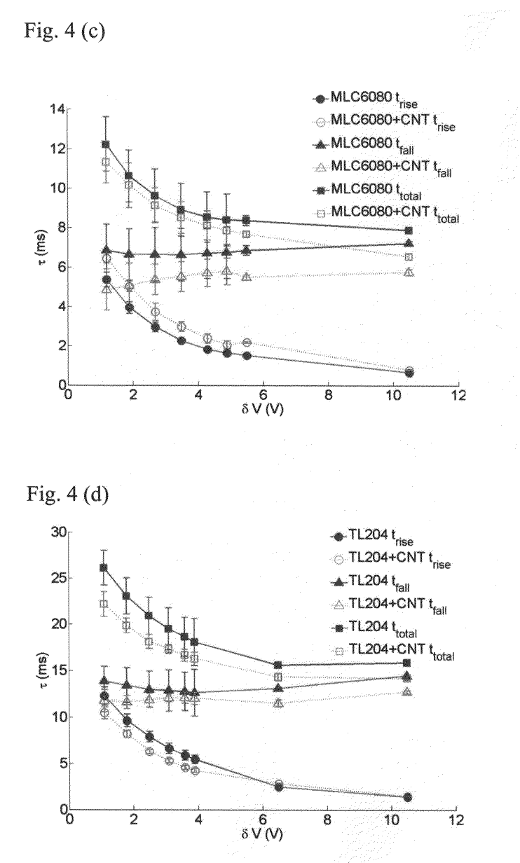

In a third example, four operable OCB cells were prepared with CNT-doped liquid crystal materials. The measured gray-level response times of the four liquid crystal materials show improvements in response time in OCB cells. In order to eliminate the effect of cell thickness from different cells, the response time was normalized with cell gap. In reference to FIGS. 4a-4d a reduced response time is defined as \acute{α}=(τ·p²)/d², where t is the measured response time and d is the cell thickness. It is indicated that after doping with carbon nanotubes, the reduced fall time of all four liquid crystal materials in OCB cells are improved. The decrease in fall time may result from the CNT changing the interaction between molecules. When the elastic constant K of the liquid crystal mixture is increased by the CNT, the response time, \acute{α}=(t·p²)/d²=γ₁/K[(V_{b}/Vₜₕ)²−1], will be decreased, and a faster response time is achieved. As shown by table 1 in FIG. 2c, the improved reduced response time is correlated to the values of bent to splay elastic constant ratios K₃/K₁ for the exemplary liquid crystals. The response times decrease for those CNTs doped liquid crystals as the increase in level of gray. The observed switching speed of rise time is plotted against the voltage between the bent state and different gray levels. This is a significant improvement in the total response time (combined rise and fall times) of CNTs doped OCB ranging from 10% to up to 26%. The effect of increase in CNT content has a similar impact on the electro-optical behavior of OCB cells.

While not limited to, the present examples are particularly adapted for use in construction of nanotube-doped liquid crystal OCB cell for displays and optical modulating devices. The present examples provide fast-switching liquid crystal cells composed of uniform alignment film deposed on the substrates, liquid crystal, and dispersion of a predetermined amount of nanotubes between the substrates. It is also an aspect of the present invention is that the nanotubes are not limited to the type of disclosed carbon nanotubes, and other nanoparticles may be usable.

In another example, a display electro-optical film (EOF) can be switched from opaque to transparent. This film may be fabricated by capillary filling, casting or coating of a mixture comprised of liquid crystal, nanotubes and prepolymer on a substrate surface or laminated between substrates. To obtain uniform electro-optical response, the EOF film can be prepared with two substrates having conductive electrode layers coated on the inside of the cell and separated with spacers to maintain constant cell gap. In one example, a display device with this EOF may employ a single substrate.

To prepare the EOF, a mixture of prepolymer, liquid crystal and an amount of nanotubes is first coated onto the substrate to form a thin layer with a coater. The casting layer is a film that, once dried or cured by heating or light exposure, the top conductive electrode can be coated and patterned. Carbon based materials and conducting polymers might be suitable in that often they can be printed to form a desired electrode pattern.

In the present examples, display components that are the same or similar to those that have previously described, will not be described in detail again; it must be understood that the previous detailed description of materials, characteristics and features of the display components applies equally to subsequently referenced to similar display components.

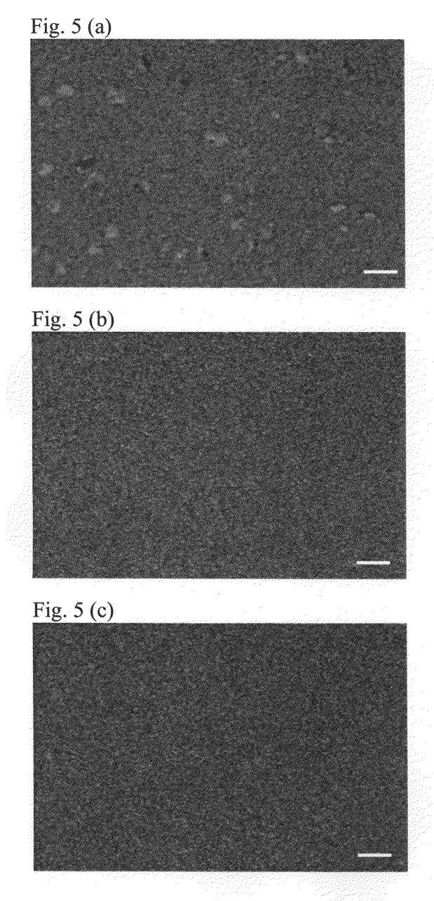

Display films of the present example have been observed under a polarizing optical microscope and the images are shown in FIGS. 5a, 5b and 5c. Once a display film has cured, the polymer encapsulated liquid crystal droplets show a dispersion of the droplet size from 1 micron to more than 20 microns as shown in FIG. 5a (the scale bar in white is 20 micron). By adding a small amount of nanotubes, e.g., 10⁻³% of carbon nanotubes (CNTs) in the composite, the cured EOF shows a homogenization in liquid crystal droplet size dispersion. The size of the droplets is smaller than one micron as shown in FIG. 5b. With further increase in the concentration of nanotubes to 10⁻²%, the cured film shows more uniformity in liquid crystal dispersion where the liquid crystal droplets are invisible under the resolution of a polarizing optical microscope, as shown in FIG. 5c. From these figures, it is shown that the sample without CNT has relatively larger droplets, and the sample with CNTs not only homogenizes the dispersion, but also induces relatively smaller droplet size.

The light transmission properties of these EOFs of the present example have been studied by determining their electro-optical performance such as transmittance versus applied voltage and response time versus applied voltage. The transmission of polymer encapsulated liquid crystal films is generally not a single-valued function of the applied field. Instead, the optic response often depends on factors including the history, interfaces and morphology of the sample as described by Drazic (Liquid Crystal Dispersions, World Scientific, 1995).

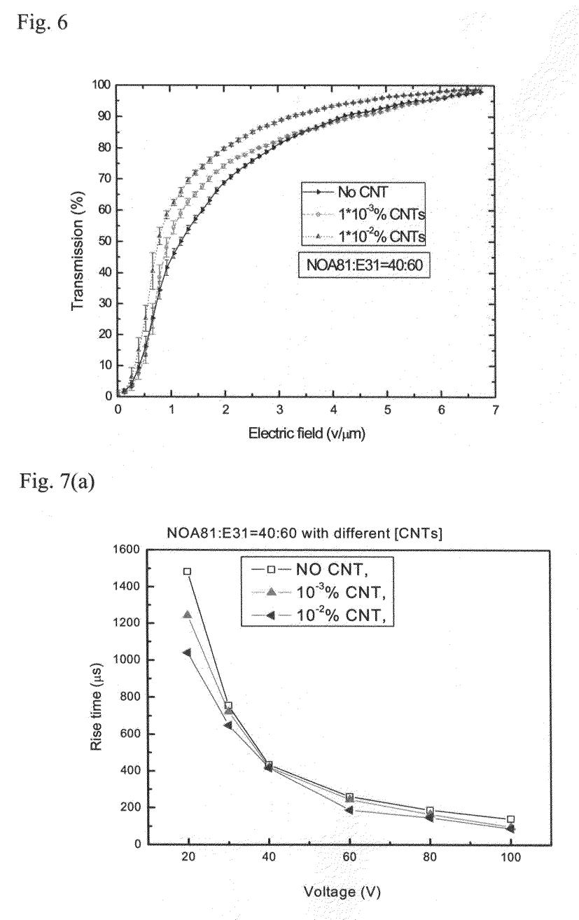

Referring to FIG. 6, the transmission, normalized by using the equation of T=(Ti−Tmin)/(Tmax−Tmin)×100%, where the Ti is the transmission of each wavelength, Tmin is the minimum transmission, and Tmax is the maximum transmission, increases with the applied voltage for all samples. The threshold voltages and the steepness of the transmittance-voltage curve for CNT-containing EOFs are either smaller or steeper than that of the EOF without CNT.

As will be further described below, the rise time (equation 1) and decay time (equation 2) can be estimated by the following two equations,

$$\begin{matrix}{τ}_{rise} \approx \frac{γ}{Δɛ {E}_{appl}^{2} - \frac{K ( {l}^{2} - 1 )}{{a}^{2}}} & ( 1 ) \\ {τ}_{decay} \approx \frac{γ {a}^{2}}{K ( {l}^{2} - 1 )} & ( 2 )\end{matrix}$$

where γ is the rotational viscosity coefficient of the liquid crystal, K is the elastic constant of the liquid crystal, l is the shape anisotropy of the droplet, α is the length of the ellipsoid major semi-axis, and Δ∈ is the permittivity anisotropy of the liquid crystal.

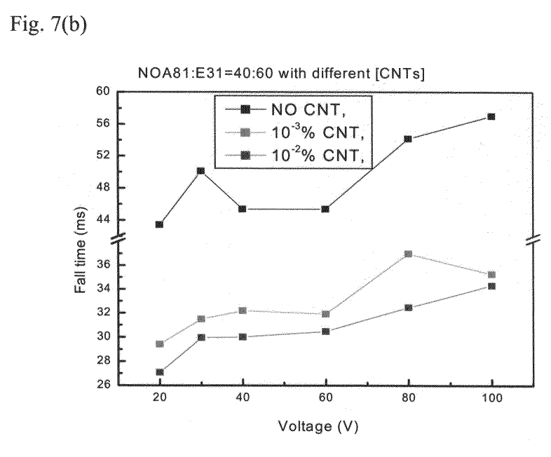

The effect of nanotubes doping on the rise times versus applied voltages is shown in FIG. 7a. The rise time is more related to the electric field and the permittivity anisotropy. In general, the EOFs containing CNTs can be switched from opaque to transparent at the speed of 200 usec with applied voltage of 4 V/um. This rise time is found to be faster than the EOF without CNTs at different grey levels. The decay time is related to the viscoelastic property of the liquid crystal. As shown in FIG. 7b, under the same applied field as referenced in FIG. 7a, the EOF with 10⁻²% CNTs has the quickest fall time.

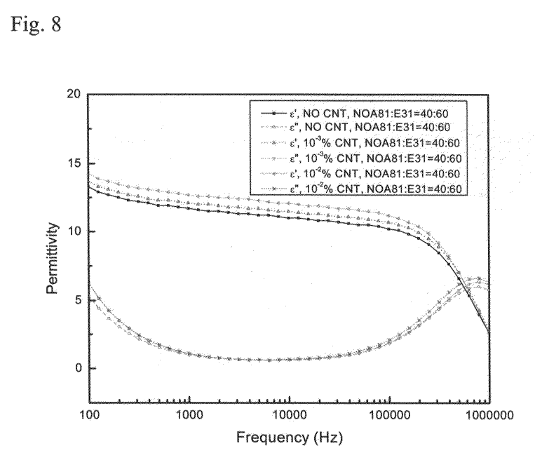

Generally, the electrical response of an EOF is dominated by the film capacitance, wherein the film capacitance depends on the dielectric permittivities of the liquid crystal and polymer components, the size of droplet dispersion, and the distribution of the two phases of the film. The effective liquid crystal dielectric constants will depend on the alignment of the liquid crystal within the film. At zero fields, the film capacitance will generally depend on the liquid crystal alignment which may vary considerably between different film constructions. The dielectric properties of the exemplary EOFs were studied by the applied field of 100 mV to the samples with thickness of 15 microns. As shown in FIG. 8, the real part of the permittivity increase with the concentration of the CNTs, while the imaginary part of the permittivity reach the maximum value at frequency 80 kHz (the dielectric relaxation frequency). Moreover, the dielectric relaxation frequency also increases with the increase of CNT concentration in the EOFs, which indicates that the average size of the liquid crystal droplets becomes smaller because of the CNT doping.

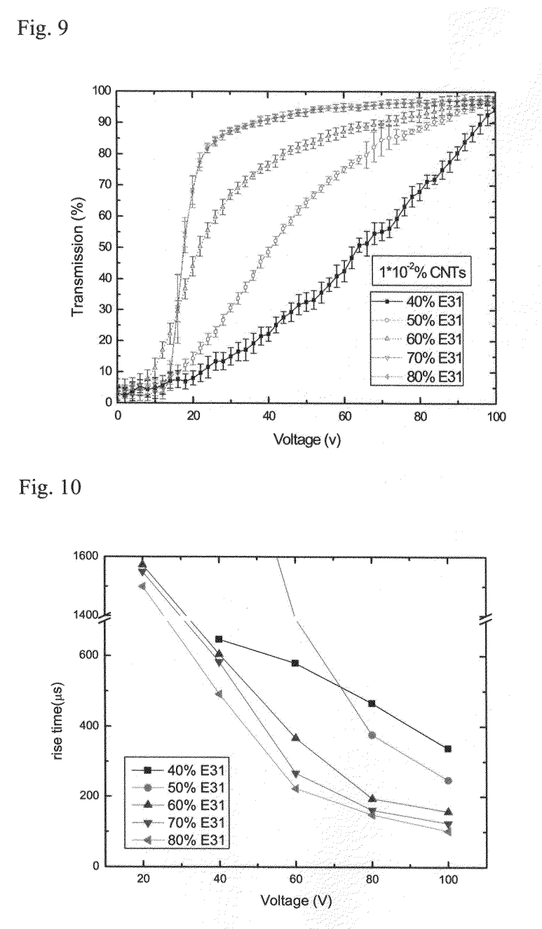

Referring to FIG. 9, there is shown the change in transmission with change in voltage for samples of varying composition. The composition of the EOFs varies by concentration of liquid crystal while maintaining the CNT concentration at 10⁻²%. The exemplary EOFs show a trend of decreasing in switching voltage and a sharp rise in the T-V curve slope with the increase in liquid crystal concentration. Furthermore, as shown in FIG. 10, the switching times (e.g. rise times) are shortened with the increase in liquid crystal concentration. In general, the switching speed is about 200 μs at the applied voltage of 5 V/μm, as shown in FIG. 10.

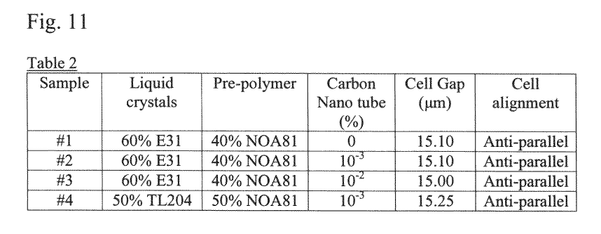

With regard to Table 2 as shown in FIG. 11, photopolymerizable dispersions have been prepared by mixing the desired composition of photomonomer (e.g., NOA 81, Norland) with a non-polymerizable liquid crystal (e.g. E31, Merck) and (carbon) nanotubes at room temperature. The polymerizable mixtures of varying amounts in component's concentration were mixed according to Table 2 in FIG. 11 resulting in the listed cell gaps and cell alignment.

In these examples, solutions of pre-polymer, liquid crystal and nanotube were vortex-mixed and loaded into the liquid crystal cells with fixed cell gap of 15 μm. The material was polymerized under a small UV light source at 1 mW/cm² intensity and 365 nm wavelength. Each cell was exposed to UV for 60 minutes at room temperature. The UV exposure wavelength and time were varied to achieve the best electro-optical performance for EOF. After polymerization, the cells were examined by a polarizing microscope and evaluated. It was determined that the droplet size was controllable and homogenized by the concentration of nanotube to liquid crystal. The system did not suffer from any pressure points when pressed, as the liquid crystal was effectively completely encapsulated.

While principles and modes of operation have been explained and illustrated with regard to particular examples, it must be understood, however, that they may be practiced otherwise than as specifically explained and illustrated without departing from the spirit or scope of the invention as defined in the appended claims.

What is claimed is:

1. A liquid crystal device comprising an amount of liquid crystal material having a predetermined amount of nanoparticles doped into the liquid crystal material, wherein the predetermined amount of nanoparticles produces fast switching mode of the liquid crystal material between bent-to-homeotropic states.

2. The liquid crystal device of claim 1 including an OCB cell containing the nanoparticles doped liquid crystal materials.

3. The liquid crystal device of claim 1 where the liquid crystal materials include nematic liquid crystals.

4. The liquid crystal device of claim 1 where the OCB cell includes a predetermined amount of carbon nanotubes in a percentage between 0.001% and 0.10% relative to the number of liquid crystals.

5. The liquid crystal device of claim 1 where the OCB cell includes a predetermined amount of carbon nanotubes in a percentage between 0.01% and 0.05% relative to the number of liquid crystals.

6. The liquid crystal device of claim 1 where the optically OCB cell is configured to operate between an optical bend state and a homeotropic state.

7. The liquid crystal device of claim 6 where the liquid crystals of the OCB cell align in the bend state in response to an application of low voltage across the cell, and align in the homeotropic state in response to an application of high voltage across the cell.

8. The liquid crystal device of claim 6 where the OCB cell is configured to not permit a substantial amount of light transmission through the OCB cell in the homeotropic state.

9. The liquid crystal device of claim 2 where the OCB cell is capable of a relatively large change in effective birefringence or variable effective birefringence enabling self-compensated optical retardation.

10. The liquid crystal device of claim 1 where the nanoparticles are carbon nanotubes.

11. The liquid crystal device of claim 9 where the carbon nanotubes range in length between 50-500 nm.

12. The liquid crystal device of claim 9 where the carbon nanotubes have a diameter of about 5 nm.

13. The liquid crystal device of claim 9 where the carbon nanotubes are concentrated in the OCB cell in a range of 0.001% to 0.10%.

14. The liquid crystal device of claim 2 where the nanoparticles are carbon nanotubes which are concentrated in the OCB cell in a range of 0.01% to 0.05%.

15. The liquid crystal device of claim 11 where the carbon nanotubes are surfactant treated carbon nanotubes.

16. The liquid crystal device of claim 15 where the carbon nanotubes are surfactant treated carbon nanotubes treated with a low-molecular-weight surfactant.

17. The liquid crystal device of claim 15 where the carbon nanotubes are surfactant treated carbon nanotubes treated with a macromolecular surfactant.

18. The liquid crystal device of claim 15 where the concentration of surfactant is between 10-50% by the weight of carbon nanotubes.

19. The liquid crystal device of claim 1 where the liquid crystals are polymer encapsulated liquid crystals which comprise an electro-optical Film with doped carbon nanotubes.

20. The liquid crystal device of claim 19 where the amount of nanotubes is between 0.001% and 0.10% relative to the liquid crytals.

21. The liquid crystal device of claim 19 where liquid crystals are homogeneously dispersed.

22. The liquid crystal device of claim 19 where the liquid crystals are dispersed in a polymer matrix.

23. The liquid crystal device of claim 19 where the liquid crystals are nematic liquid crystals.

24. The liquid crystal device of claim 19 where the polymer encapsulated liquid crystals form droplets with a dispersion of droplet size of 1 micron or smaller.
